(19) United States
(12) Patent Application Publication
(10) Pub. No.: US 2016/0307453 A1
(43) Pub. Date: Oct. 20, 2016

(54) SYSTEM AND METHOD FOR AUDITORY CAPACITY DEVELOPMENT FOR LANGUAGE PROCESSING

(71) Applicant: Kadho Inc., Irvine, CA (US)

(72) Inventors: Dhonam Pemba, Toluca Lake, CA (US); Kaveh Azartash, Aliso Viejo, CA (US)

(21) Appl. No.: 14/688,198

(22) Filed: Apr. 16, 2015

(51) Int. Cl. G09B 5/06; G09B 19/04; G09B 19/06

(52) U.S. Cl. CPC G09B 5/065; G09B 19/06; G09B 19/04

(57) ABSTRACT

An interactive auditory capacity development method and system for language processing wherein a phonetic element of a language is introduced to a user and the user is then provided with an interactive environment on a device for processing the phonetic element. The processing may include identification and comparison of the phonetic element with other sounds retrieved from a database. The interactive environment evaluates the user input and provides feedback to the user. The device used for providing the interactive environment to the user may include a smart phone, tablet or a physical toy.

### BACKGROUND

Ability to communicate in more than one language has become a desirable attribute today. Technology has played an important role in connecting people from different countries and continents and making cross border interactions a reality. More and more people wish that they and their children are able to speak and communicate in more than one language. This multilingual capability adds a competitive edge in the culturally diverse business environment that exists today.

People wanting to learn a second language usually find it difficult to understand the pronunciation of phonemes and syllables of the language, resulting in either giving up learning the language mid-way or poor fluency in the language. Phonemes are considered as the smallest identifiable unit of sound in any language. The combination of these phonemes results in syllables which in turn form words of a language. People who make attempts of learning to speak a second/non-native language usually face difficulty in understanding the phonemes and syllables of the language and hence are not able to grasp the language completely or are not able to bring about fluency in speaking the second language. For example Korean language possesses both ‘r’ and ‘l’ sound where [r] occurs usually in the middle and [l] at the end of words. This means that while Korean speakers will not have difficulty producing [l] at the end of words in another languages, they will have difficulty with most European languages, which also allow [l] at the beginning of words. However, such difficulty is not faced in understanding the phonemes, syllables and other phonetic components of the native language.

Research and studies have shown that the one significant reason why a person is able to easily identify and relate to the phonemes, syllables and other phonetic components of his or her native language is because of exposure to native language at a very early age. Eric Heinz Lenneberg, a pioneering scientist on language acquisition and cognitive psychology, hypothesized that the best time of acquiring a language or at least getting used to phonemes of a language is within a critical period. If language is not learned before this time period, then an individual is not able to completely understand the phonemes and other sound components of the language at a later stage. This is because a child's auditory capabilities are sharp enough to differentiate and register multiple sounds, phonemes and syllables. An early exposure to sound elements such as phonemes and syllables from non-native languages form permanent phonological memory traces that help the adult to learn the language at a later stage.

Though a lot of different methods and systems are known in the art that relate to helping individuals, learn a second language, they are unable to bring about fluency as the individuals often find the pronunciation confusing and difficult. Other methods and systems that concentrate upon teaching a second language or teaching pronunciation to children often miss the critical aspect of exposing the children to phonemes, syllables and sounds from multiple languages for creating phonological memory traces. Yet other language acquisition methods are not able to make the environment fun and interactive enough and children become disinterested in learning. Even toys available in the market teach very basic alphabet skills with little to no exposure to phonemes or syllables.

### SUMMARY OF THE INVENTION

The method provided herein relates to a method for developing auditory capability of a user to process language sounds. The method comprises introducing at least one phonetic component specific to at least one language to the user, presenting the user with an interactive environment on a device, soliciting the user's response related to processing of the phonetic component within the interactive environment through the device and evaluating the user's response. The method may further comprise of retrieving another phonetic component from a database of phonetic components based on the user's response. Another phonetic component may be retrieved from the database based on adaptive logic. In one embodiment, the method may further comprise increasing or decreasing the difficulty level of the interactive environment automatically based on the user's performance.

The method may further comprise inducing distraction sounds to increase difficulty level of the interactive environment. In one embodiment, the interactive environment may be a video game environment. The video game environment may automatically display specific game scenarios based on user-entered parameters. In another embodiment of the invention, interactive environment may be a physical toy comprising a battery unit, an audio output unit and a microphone. The physical toy may further comprise a touch capacitive video display screen. The physical toy may be further configured to provide gestural, audio or video response based on the user input.

The phonetic component corresponding to a language may be a phoneme, grapheme, allophone or a syllable. The phonetic component may be chosen from multiple languages. The interactive environment may permit the user to use the phonemes, graphemes, allophones or syllables to build words and sentences. Evaluation of the user's performance may be provided by automatic displaying of performance analytics data using a radar plot wherein percentage of sounds identified from the database are highlighted.

In one embodiment processing the phonetic components may involve distinguishing from other components, identification of components within the interactive environment, or using components to build words and sentences. The user response may be solicited using audio input means to capture user's voice as input, a touch capacitive display or an augmented reality system capturing the user's gestures.

### BRIEF DESCRIPTION OF THE DRAWINGS

FIG. 1. FIG. 1 illustrates a flow diagram of one embodiment of the invention

FIG. 2. FIG. 2 is an illustrative snapshot of a video game interactive environment presented to the user

FIG. 3. FIG. 3 is an illustrative snapshot of a video game interactive environment wherein the score is depicted and the game environment provides a continuous visual feedback to user's performance.

FIG. 4. FIG. 4 FIG. 4 is an illustrative screen shot of a video game interactive environment wherein the user is required to match sounds of phonetic components.

FIG. 5. FIG. 5 FIG. 5 is an illustrative screen shot of a video game interactive environment wherein the user is required to identify objects related to a specific sound.

FIG. 6. FIG. 6 is an illustrative screenshot of a video game environment for managing of user profiles.

FIG. 7. FIG. 7 is an illustrative embodiment of a physical interactive toy.

FIG. 8. FIG. 8 is an illustrative embodiment of arrangement and ranking of phonetic components in a database.

FIG. 9. FIG. 9 is an illustrative embodiment of manner of retrieval of phonetic components from a database.

### DETAILED DESCRIPTION

The embodiments herein and the various features and advantageous details thereof are explained with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the scope of this patent application and the claims contained herein should not be construed as limited to the illustrative embodiments.

The auditory capability development method for assisting a user to process language sounds, disclosed herein, provides that a phonetic component of a language is introduced to a user. This phonetic component may be a phoneme, grapheme, allophone or a syllable or any other related sounds. For the purposes of this description the term “user” may mean and include a person of any age, however, scientific studies have shown that this method is most effective for children up to the age of six years. Once the phonetic component is introduced to the user, the user is provided an interactive environment where the user is expected to identify and/or process the phonetic component within such interactive environment. The interactive environment thereafter evaluates the user input and provides appropriate response.

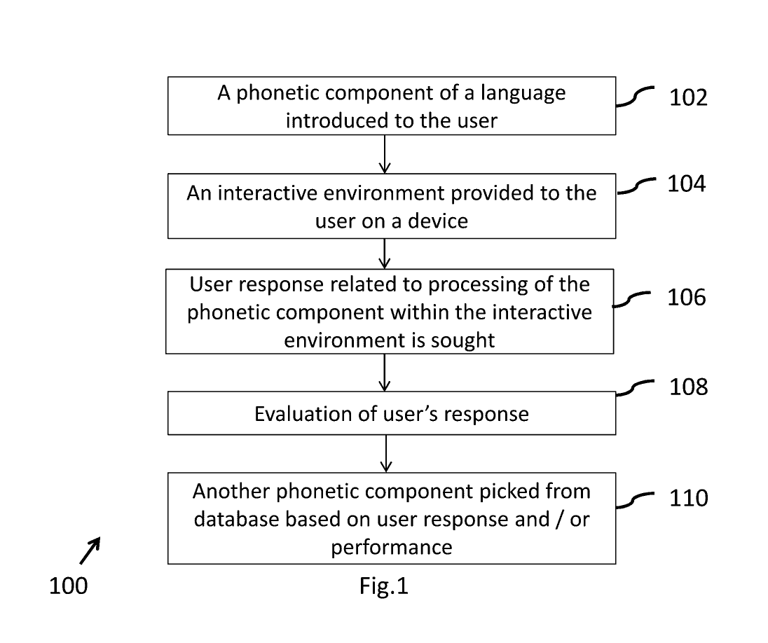

FIG. 1 is an illustrative flow diagram 100 of an embodiment of the method provided herein. A phonetic component of a language is introduced to the user 102. This phonetic component may be a phoneme, grapheme, allophone or a syllable and it may be introduced to the user by playing the phonetic component using audio output mechanism of a device. This device may be a computing device, mobile phone, tablet, smart phone or a toy specifically designed for such purpose. Multiple phonetic components may be introduced at the same time based on the age and auditory capability of the user. The phonetic components may be related to one language or multiple languages. Once the phonetic component is introduced to the user 102, the user is provided an interactive environment on a device 104. In one embodiment, this interactive environment may be a video game environment that encourages the user to identify or process the phonetic component 106 learnt earlier within the rules of such video game environment. The video game environment may automatically display specific game scenarios based on user-entered parameters. For example if the user enters parameters such as age, ethnicity and language to be learnt then the video game environment may display a game scenario best suited for the purpose. In an alternate embodiment, the device presenting the interactive environment may be a physical toy that utilizes the method provided herein. The toy may comprise of a battery unit, an audio output unit and a microphone to enable the user to interact with the toy. The toy may also comprise of a capacitive touch screen display to enhance the interaction experience of the user.

The interactive environment presented to the user is configured to solicit a user response related to the identification or processing of the phonetic component learnt by the user earlier. The processing may involve distinguishing the specific phonetic component from other sounds, identification of components, or using components to build words and sentences. Various ways such as employing distraction sounds, increasing number of objects to confuse the user etc. may be used to increase the difficulty level. The interactive environment may optionally be configured to increase or decrease the difficulty level automatically based on user performance. The user input may be sought using an audio input device that receives the user's voice as input. Alternatively capacitive touch screen of the device or augmented reality system that captures user's gestures may be used to receive user input. The interactive system may also be configured to permit the user to make words and sentences by utilizing the identified phonetic components.

The user response is evaluated 108 based on set parameters and the evaluation is displayed on the device to the user. In one embodiment, the evaluation is displayed in the form of automatic displaying of performance analytics data using a radar plot wherein percentage of sounds identified from a database is highlighted. Based on the user response the interactive environment may be configured to retrieve another phonetic component from a database of phonetic components 110. This database of phonetic components may either reside on a server (including cloud server) remotely connected to the device or it may be stored on local memory of the device. The additional phonetic components may be retrieved from the database based on adaptive logic. This adaptive logic may be customized based on parameters such as performance of the user, language that the user is looking to learn, language pack chosen etc. In one embodiment wherein the device is a physical toy, the toy may be configured to provide gestural, audio or video response based on said user input as evaluation.

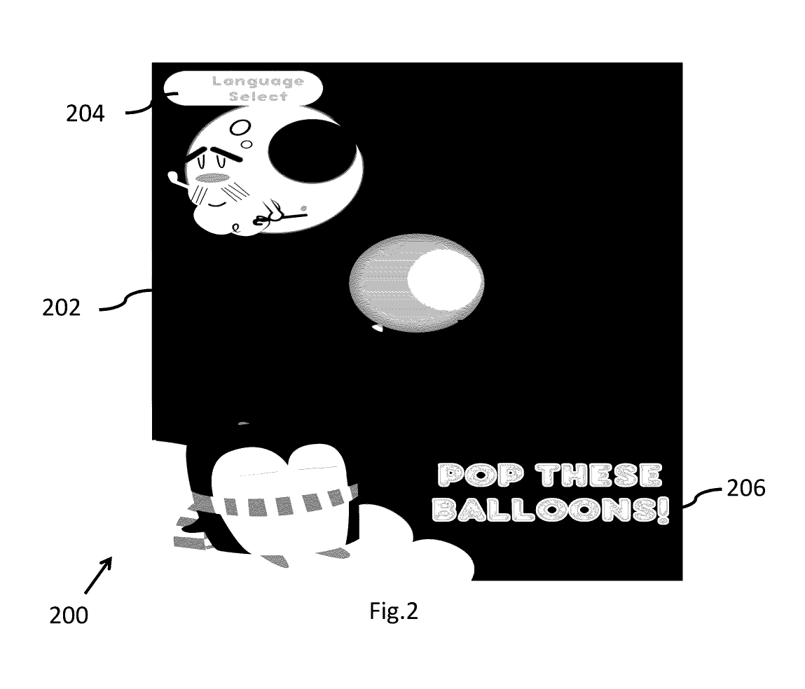

FIG. 2 is an illustrative screenshot 200 of a video game interactive environment wherein the game environment is displayed on a device screen 202 and the user is able to choose a specific language 204 that the user wishes to familiarize with. In case of a child this specific language may be selected by parents or guardians. In an alternate embodiment, the user may be asked to enter the parameters based on which the language is selected automatically or there may be a multilanguage mode wherein phonetic components of multiple languages are introduced to the user and become a part of the game play. The user is provided a written instruction 206 to carry out an action. In this case the action is to pop the balloon 208. Once the user pops the balloon, a specific phonetic component is played through the audio output of the device. This way a phonetic component is introduced to the user and the user familiarizes itself with such phonetic component. Optionally, multiple phonetic components from a single language or multiple languages may be introduced to the user at the beginning of the game play.

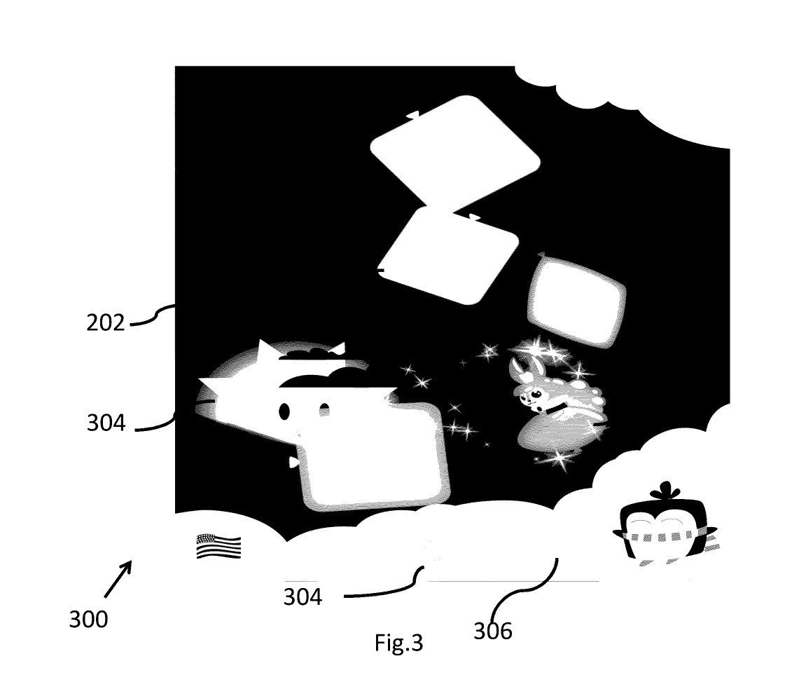

FIG. 3 is an illustrative screenshot 300 of an embodiment wherein the video game interactive environment provides a response to the user based on user input. One the user starts popping the balloons 208, for every right balloon popped by the user, a fairy 302 greets the user and provides a positive reinforcement that the user is doing well. For every wrong balloon popped, the sun 304 sets a little bit further thereby giving an indication that the user has to perform better to make sure that the sun does not set completely. The game may automatically end once the sun 304 sets completely. Other similar interactive setting may be used to provide continuous feedback to the user. The game environment may also provide a numerical score 304 to the user based on the number of correct balloons popped and also a score multiplier 306 to enable the user to know the overall score based on performance.

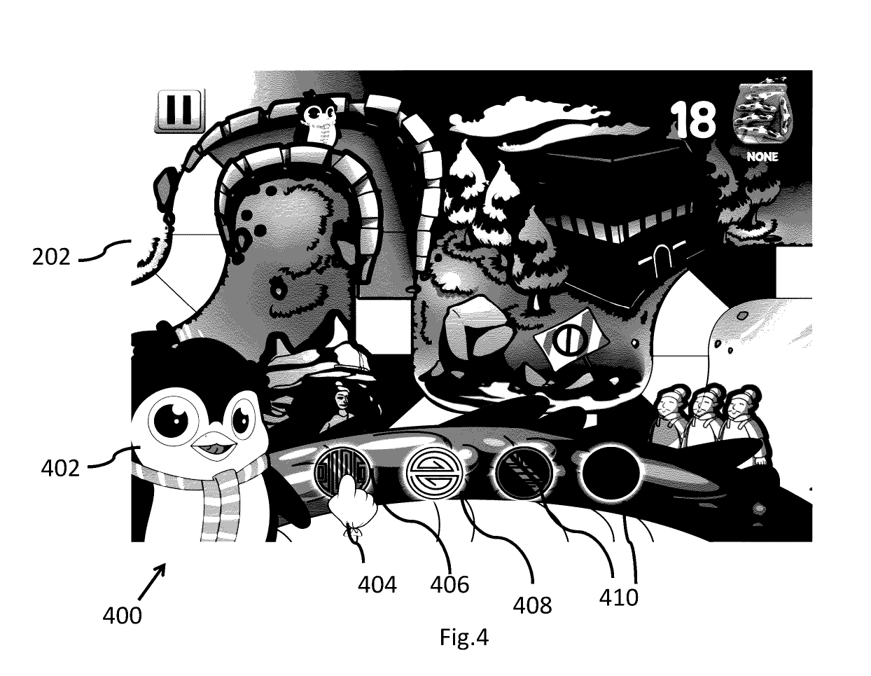

FIG. 4 is an illustrative screenshot 400 of a game setting wherein the device screen 202 displays a penguin 402 that produces a specific sound. This sound may be a specific phonetic component of a language. Alternatively, in a more difficult game setting, the penguin 402 may produce multiple sounds out of which one or few may be phonetic components while other sounds may be incorporated to confuse the user. Once the user hears the sound produced by the penguin 402, the user is required to use a pointer 404 to click on the first sound producing icon 406 and compare if the sound produced by clicking the first icon 406 is the same as the sound produced by the penguin 402. Thereafter, the user moves to the second sound producing icon 408 and again provides an input as to whether the sound produced is similar to the sound produced by the penguin 402. This way the user continues to identify and match sounds by clicking on the other sound producing icons 410. The sound may be produced with the help of audio output means such as speakers present in the device. The sound to be produced by the penguin and/or by the sound producing icons may be retrieved from a database of sounds based on an adaptive logic.

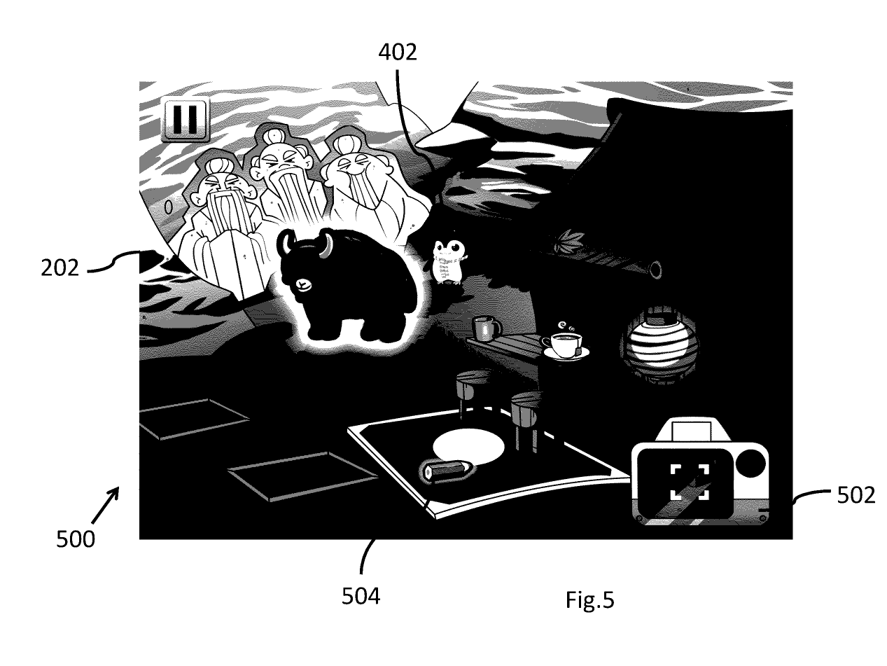

FIG. 5 is an illustrative screen shot 500 of a game setting wherein the penguin 402 produces specific sound corresponding to phonetic components of at least one language and the user is required to identify objects that represent the sound. Herein the user is required to identify an object that corresponds to the sound of [P]. The user is supposed to utilize a camera 502 provided in the game setting to click the image of the object (pencil in this case) 504 to correctly identify the object. In case the user clicks the image of a wrong object, then either the game may terminate or the game may automatically go to a lower difficulty level or setting.

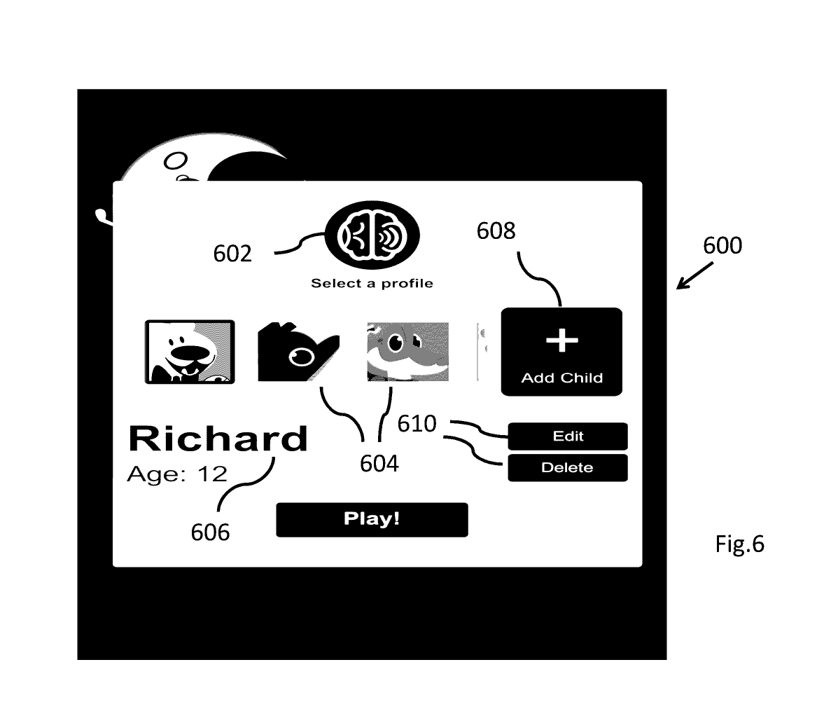

FIG. 6 is an illustrative screen shot 600 of a video game environment wherein the user or the parent or guardian may choose specific profiles 602 based on which user wants to play. This makes this perfect for a school or a family setting wherein multiple students or children can play on the same device. Selecting a specific profile picture 604 displays the name 606 and age of the corresponding user. This helps the parent, teacher or guardian keep a track of the user's performance. Options such as adding 608 a new profile and editing and deleting 610 profiles may also be available.

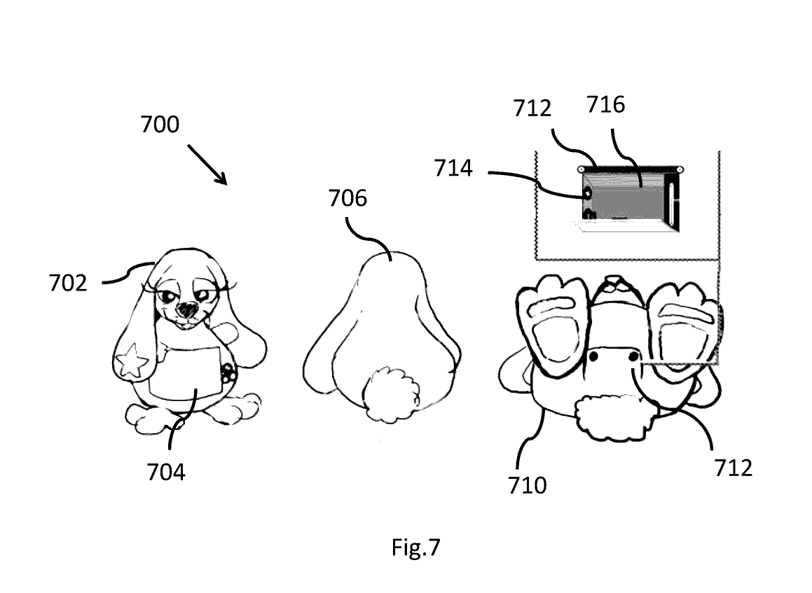

FIG. 7 is an illustrative embodiment 700 of the device using the method provided herein being a physical toy 702. The toy may either be specifically manufactured for such purpose or an off the shelf toy with a screen and Internet connectivity may be used. In the specific example shown, the toy 702 has a touch capacitive screen 704 for displaying the interactive environment and for soliciting user input. The toy 702 may also have a microphone for receiving user voice as input. The back portion 706 of the toy 702 may be like any other toy and may be made attractive and creative for keeping the user interested. The bottom portion 710 of the toy may contain a housing 712 which may be configured to contain a battery 714 and a local hard drive 716 for storing database of sounds and user input. The toy may also have the provision of providing gestural, audio or video response/feedback based on user input.

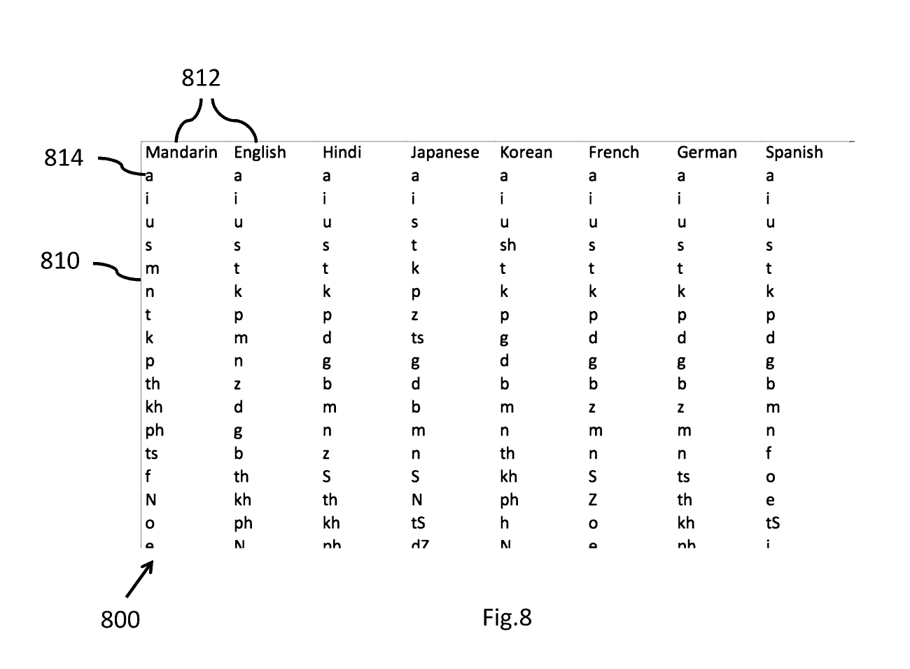

FIG. 8 depicts an illustrative embodiment 800 of a manner of arrangement of phonetic components in a database 810 of sounds. The phonemes, syllables, words and any other phonetic components are ranked in the database 810. The ranking may be based on linguistic difficulty, a child's natural pronunciation order or any other sort of ranking based on use case. The figure depicts ranking of phonetic components from multiple languages 812 based on the difficulty of pronunciation with the easiest to pronounce phoneme 814 placed at the top of the table. The user may get the easiest ones first, and based on user response, the next sound retrieved in the database may be more advanced. Moving down the rankings can either be based on a probability matrix that helps chose the next sound or it can just move down a list through an algorithm such as moving linear, weighted randomly etc. Syllables may also be ranked according to the consonant and vowel combinations, as well as the type of phonemes making up the syllables. The types of phonemes making up the syllables are described with notation such as (Stop, Vowel, Nasal) or FGVA (Fricative, Glide, Vowel, Affricate), which denote the manner of articulation of each sound. For each language the syllables are ranked. In an alternate embodiment words follow a similar method as syllables, where the word is ranked by the combinations of syllables that make up the word.

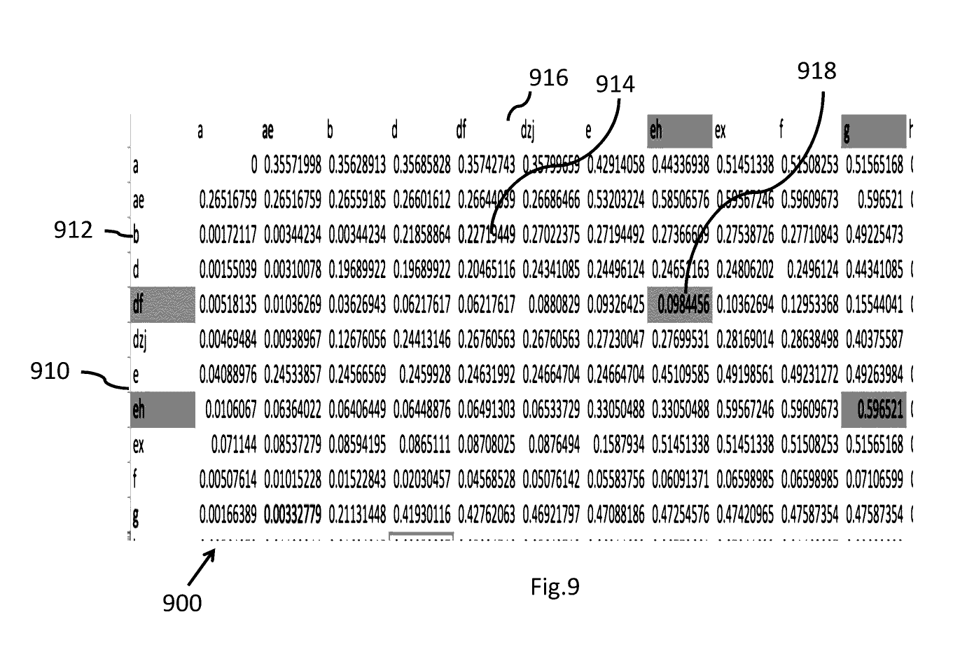

FIG. 9 depicts an illustrative embodiment 900 of a manner of retrieval of phonetic components from a database 910. The first sound [b] 912 is chosen randomly. Thereafter, a random number 914 between 0 and 1 is generated. In the current example the number is [0.227] 914. The sound corresponding to this random number 914 is then picked next. In this case the sound corresponding to the random number [0.227] 914 is [df] 916. Once [df] 916 is picked, another random number 918 from the [df] row is picked and then the sound corresponding to the random number 918 is picked and this manner of retrieval continues. In an alternate embodiment, the manner of retrieval may adapt based on user response and performance.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for developing auditory capability of a user to process language sounds, said method comprising:
introducing at least one phonetic component specific to at least one language to said user;
presenting said user with an interactive environment on a device;
soliciting said user's response related to processing of said phonetic component in said interactive environment through said device; and
evaluating said user's response.

2. The method of claim 1, further comprising retrieving another phonetic component from a database of phonetic components based on said user's response.

3. The method of claim 2 wherein said database is configured to permit retrieval of said another phonetic component based on adaptive logic.

4. The method of claim 2, further comprising increasing or decreasing difficulty level of said another phonetic component automatically based on said user's performance.

5. The method of claim 1, further comprising increasing or decreasing the difficulty level of said interactive environment automatically based on said user's performance.

6. The method of claim 1, further comprising inducing distraction sounds to increase difficulty level.

7. The method of claim 1, wherein said interactive environment is a video game environment.

8. The method of claim 7, wherein said video game environment automatically displays specific game scenarios based on user entered parameters.

9. The method of claim 1, wherein said device is a physical toy comprising a battery unit, an audio output unit and a microphone.

10. The method of claim 9, wherein said physical toy further comprising a touch capacitive video display screen.

11. The method of claim 9, wherein said physical toy is configured to provide gestural, audio or video response based on said user input.

12. The method of claim 1, wherein said device is a smart phone, tablet or a computing device.

13. The method of claim 1, wherein said phonetic component may be a phoneme, grapheme, allophone or a syllable.

14. The method of claim 1, wherein said phonetic component may be chosen from different languages.

15. The method of claim 1, wherein said interactive environment is configured to permit said user to build words and sentences.

16. The method of claim 1, wherein processing of said phonetic components may involve one of distinguishing from other components, identification of components, and using components to build words and sentences.

17. The method of claim 1, wherein said user response is solicited using an audio input device that receives the user's voice as input.

18. The method of claim 1, wherein said user response is solicited using touch interface of a computing or mobile device.

19. The method of claim 1, wherein said user response is solicited using augmented reality system capturing said user's gestures.

20. The method of claim 1, wherein said evaluation is provided by automatic displaying of performance analytics data using a radar plot wherein percentage of sounds identified from said database are highlighted.

21. An auditory development system on a device comprising:
a storage means for storing a database of phonetic components;
an input means configured to receive a user's input regarding identification or processing of at least one phonetic component of at least one language;
an output means configured to provide response based on said user's input; and
an evaluation engine configured to provide evaluation of said user's performance.

22. The system of claim 21, wherein said device is a computing or mobile device

23. The system of claim 21, wherein said device is a physical toy.

24. The system of claim 21, wherein said storage means is cloud server storage.

25. The system of claim 21, wherein said storage means is local storage space on said device.

26. The system of claim 21, further comprising a capacitive touch screen display for soliciting said user's response and for displaying response based on said user's input.

27. The system of claim 21, wherein said input means for soliciting response is an augmented reality system capturing said user's gestures.
